(19) United States
(12) Patent Application Publication
(10) Pub. No.: US 2005/0176609 A1
(43) Pub. Date: Aug. 11, 2005

(54) Branched fatty acid derivatives as anti-gelling or viscosity-control ingredients

(76) Inventors: Ferdinand Naef, Carouge (CH); Thierry Stora, Thoiry (FR); Olivier Haefliger, Chene-Bourg (CH)

Correspondence Address: WINSTON & STRAWN LLP, 1700 K STREET, N.W., WASHINGTON, DC, 20006, US

(21) Appl. No.: 10/988,016

(22) Filed: Nov. 12, 2004

Related U.S. Application Data
(63) Continuation of application No. PCT/IB03/01970, filed on May 13, 2003.

(30) Foreign Application Priority Data
May 13, 2002 (WO) PCT/IB02/01661

(51) Int. Cl. C11D 1/00

(52) U.S. Cl. 510/276; 510/499

(57) ABSTRACT

The present invention relates to a quaternized amine ester derivative which is useful as anti-gelling or viscosity-control ingredient in softening articles, especially fabric softener. The quaternized amine ester derivative is a compound derived from a 3-(dialkylamino)-1,2-propanediol and a non-linear fatty acid, such as isostearic acid.

### CROSS-REFERENCE TO RELATED APPLICATIONS

This application is a continuation of International application PCT/IB03/01970 filed May 13, 2003, the entire content of which is expressly incorporated herein by reference thereto.

### TECHNICAL FIELD

The present invention relates to the field of softeners. More particularly, the invention concerns a compound derived from a 3-(dialkylamino)-1,2-propanediol and a non-linear fatty acid, as well as the use of the compound as anti-gelling or viscosity-control ingredient in softening articles.

### BACKGROUND ART

Gelation of softening articles is a known problem which is notably enhanced, at low or high temperature, by a prolonged storage time and/or the presence of alcohols, in particular perfumery alcohols. This gelation manifests itself macroscopically by an increase of the composition viscosity and a concomitant and irreversible thickening, or sometimes even by a solidification of the softener compositions. The gelation is believed to be due to the surfactants present in composition, and possibly to the interactions of the surfactants with other ingredients. To the best of our knowledge, all existing or commercial softener compositions contain surfactants which have a linear chain residue.

In order to solve or to lessen the problem of the physical stability of softener compositions only few solutions have been suggested in the prior art. EP 280550 discloses the use of non-ionic surfactants, e.g. alkoxylated aliphatic alcohols, as a viscosity-control agent or an anti-gelling ingredient in softener compositions containing not more that 6% of a cationic fabric softener and a free fatty acid. Alternatively, WO 95/22594 teaches the use of a perfume which is associated with a carrier to avoid the gelation of bases containing ionic surfactants; however this solution is useful only when the gelation is due to the sole perfume. Still to prevent the viscosity problems in perfumed compositions comprising ionic surfactants, WO 97/17419 proposes to use specific non-ionic di- or tri-esters.

However, the above-mentioned solutions are either limited to a use in softening articles which must contain a perfume and/or are not optimal solutions in the sense that they are limited to only a specific range of formulations.

Therefore there is still a need for an anti-gelling ingredient, or viscosity-control agent, able to perform in a larger range of conditions and/or of formulations, including in the absence of perfumes.

### SUMMARY OF THE INVENTION

The present invention relates to a particular compound according to formula I, as described herein, for use as an anti-gelling or viscosity-control agent or ingredient for softener compositions. Preferably, the compound is present in a composition of matter that includes a perfume base.

The invention also relates to a method for preventing or delaying gelation of a softener composition, which comprises adding to or incorporating in such composition (a) a compound of formula I as described herein or (b) an anti-gelling or viscosity control agent or (c) a composition of matter according to the invention, wherein the compound is present in an amount effective to prevent or delay gelation of the softener composition.

### DETAILED DESCRIPTION OF THE PREFERRED EMBODIMENTS

To overcome the problems due to the gelation, a compound of formula I is used an anti-gelling or viscosity-control ingredient, i.e., one capable of preventing or delaying the gelation of a softener composition. This compound is a non-linear fatty acid derivative. The term “non-linear fatty acid” means a fatty acid having at least a tertiary carbon atom in its hydrocarbon radical, or a fatty acid having up to six hydroxyl groups, with the hydroxyl groups being possibly derivatized as ethers or esters bonded to its hydrocarbon radical. By “a fatty acid having at least a tertiary carbon atom in its hydrocarbon radical” what is meant is a fatty acid containing a moiety which is cyclic, aromatic or branched. Non-limiting examples of such non-linear fatty acids are of the formulae (a), (b) or (c) wherein the asterisk indicate one of the tertiary carbon atom:

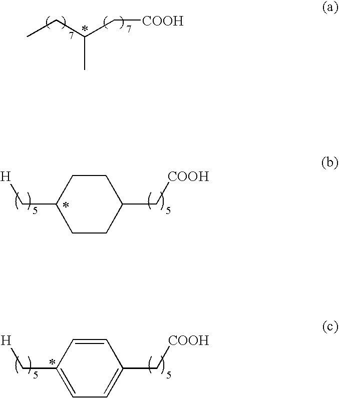

Suitable compounds for the purpose of the invention, e.g. for a use as anti-gelling ingredient in a softening articles, are of formula 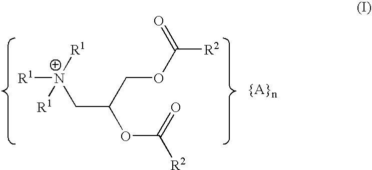
wherein n is 0.5 or 1;
A represents an anion of an acid such as a chloride, a bromide, a iodide, a CO₃²⁻ or HCO₃₋, a sulfate, a methyl or ethyl sulfate, a tosylate or a nitrate; and
each R¹ represents, simultaneously or independently, a hydrogen or oxygen atom, a benzyl or C₁ to C₆ alkyl group or a polyethylene- or polypropyleneglycol group, having from 1 to 5 monomer units; and
each R² represents, simultaneously or independently, a C₁₀-C₃₀ saturated or unsaturated hydrocarbon radical having at least a tertiary carbon atom, or a C₁₀-C₃₀ saturated or unsaturated hydrocarbon radical having from one to six —OCOR³ or —OR³ groups bonded to its hydrocarbon chain; R³ being an hydrogen atom, or a C₁-C₂₂ saturated or unsaturated hydrocarbon group.

According to a particular embodiment of the invention, the compounds of formula (I) are those wherein n is 0.5 or 1;
A represents a chloride, a bromide, a iodide, a sulfate or a methyl or ethyl sulfate;
each R¹ represents, simultaneously or independently, an oxygen atom, a benzyl or C₁ to C₆ alkyl group or a —[CH₂CH₂O]_{q}H group, q being an integer from 1 to 3; and each R² represents, simultaneously or independently, a C₁₄-C₁₈ saturated or unsaturated hydrocarbon radical having at least a tertiary carbon atom, or a C₁₄-C₂₀ saturated or unsaturated hydrocarbon radical having from one to six —OCOR³ or —OR³ groups bonded to its hydrocarbon chain; R³ being an hydrogen atom, or a C₁-C₁₈ saturated or unsaturated hydrocarbon group.

According to yet another particular embodiment of the invention, the compounds of formula (D) wherein n is 0.5 or 1;
A represents a chloride, a bromide, a iodide, a sulfate or a methyl or ethyl sulfate;
each R¹ represents, simultaneously or independently, a benzyl or C₁ to C₆ alkyl group; and
each R² represents, simultaneously or independently, a C₁₄-C₁₈ saturated or unsaturated hydrocarbon radical having from one to six tertiary carbon atoms;
are particularly praised, especially if at least one of the R² of the embodiment is a C₁₇ hydrocarbon containing a C₁₆ or C₁₅ linear hydrocarbon substituted with one or two methyl groups, respectively, or containing a cyclic moiety and one or two chain moieties.

The compounds of the invention may be obtainable by the reaction of one molar equivalent of an appropriate alkandiol amine of formula 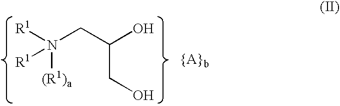
in which R¹ and A are as defined in formula (I), and a=b=0 or a is 1 and b is 0.5 or 1;
with approximately two molar equivalents of a fatty acid R²COOH (preferably in the presence of an acid catalyst), or the corresponding acyl chloride R²COCl or triglyceride derivative, and subsequently, if a is 0, the product thus obtained may be quaternized. As source of the fatty acid R²COOH (R² being defined as in formula (I)), or of the corresponding triglyceride, it will be preferably used a natural oil or a product obtained by a transformation of a natural oil, example of such oils are isostearic acids, hydroxystearic acid, ricinoleic acid or polyterpenic acids such as farnesic acid.

A specific example of this approach is illustrated in Scheme (D): 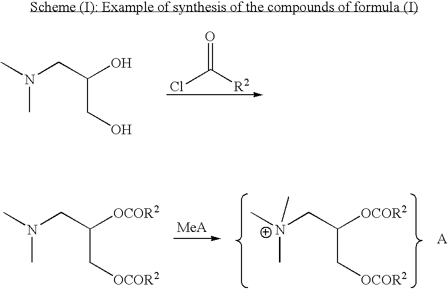
wherein the symbols R² and A have the same meaning as defined in formula (I).

These methods are conventional processes, which are well known to a person skilled in the art of the organic synthesis, and therefore do not need a more detailed description.

As previously mentioned, one of the objects of the present invention is the use as anti-gelling or viscosity-control ingredient of a compound of formula (I). In other words, the use consists of a method to prevent or delay the gelation of a softening article, which method comprises adding to the article an effective amount of at least one compound of formula (I). By “use of a compound of formula (I)” it has to be understood here also the use of the compound (I) in any of its forms which can be advantageously employed as anti-gelling ingredient.

The various forms are also embodiments of the present invention. In one embodiment, one of the forms is a composition of matter consisting of at least one compound of formula (I) and a perfume base. Therefore, in such an embodiment, one of the elements which may be at the origin of the gelling phenomenon is admixed with the anti-gel ingredient, and therefore the two ingredients will be added at the same time into the softener base, minimizing thus any risk of formation of gel into the softening article.

Generally speaking, by “perfume base” we mean here a composition comprising at least one perfuming compound and possibly one or more solvents or adjuvants commonly used in the perfume industry. By “perfuming compound” it is meant here a compound, which is of current use in the perfume industry, i.e. a compound which is used as ingredient in perfuming preparation or composition in order to impart an hedonic effect. In other words, such a compound, to be considered as being a perfuming one, must be recognized by a person skilled in the art as being able to impart or modify in a positive or pleasant way the odor of a composition, and not just as having an odor. Its is therefore understood here that any mixture resulting directly from a chemical synthesis in which the compound of the invention is involved as a starting intermediate or as an end-product is not a composition of matter according to the invention.

The nature and type of the perfuming compounds present in the base do not warrant a more detailed description here, which in any case would not be exhaustive, the skilled person being able to select them on the basis of its general knowledge and according to intended use or application and the desired organoleptic effect. In general terms, these perfuming co-ingredients belong to chemical classes as varied as alcohols, aldehydes, ketones, esters, ethers, acetates, nitrites, terpene hydrocarbons, nitrogenous or sulphurous heterocyclic compounds and essential oils of natural or synthetic origin. Many of these co-ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery.

For purpose of the invention, perfume bases which contain alcohols or aldehydes, as perfuming compounds, are particularly interesting.

Similarly, a detailed description of the nature and type of solvents and adjuvants commonly used in perfume bases cannot be exhaustive. A skilled person in the art is able to select them on the basis of the nature of the product to be perfumed. However, as non-limiting examples of solvents commonly used in perfumery bases, one can cite compounds such as dipropyleneglycol, diethyl phthalate, isopropyl myristate, benzyl benzoate, 2-(2-ethoxyethoxy)-1-ethanol or ethyl citrate, which are the most commonly used.

As the invention's compounds are suitable anti-gelling ingredients, another embodiment of the present invention is a softening article comprising:
a) a compound of formula (I), as defined above, or a composition of matter, as defined above, and
b) a softening base.

For the sake of clarity, it has to be mentioned that, by “softening base” what is meant is an unperfumed softener, i.e. a consumable product which has no perfuming compound and is intended for the care of a surface, such as fabrics, hair or skin, or a part of the softener. Therefore, a perfumed product according to the invention comprises at least a part of the whole formulation corresponding to an unperfumed softener, e.g. one or more suitable surfactant, an anti-gel effective amount of at least an invention's compound and possibly an olfactive effective amount of a perfume base as defined above.

The nature and type of the constituents of the softening base do not warrant a more detailed description here, which in any case would not be exhaustive, the skilled person being able to select them on the basis of its general knowledge and according to the nature and the desired effect of the product.

Suitable softening bases comprise fabric softeners, shampoos, hair conditioners and other hair care products or yet skin emollients or cosmetic products. The fabric softeners being the preferred bases.

According to a particular embodiment of the invention, the softening base advantageously contains at least a surfactant obtainable by the reaction of one to three molar equivalents of a C₁₀-C₂₀ fatty acid with one molar equivalent of an amino alcohol of formula 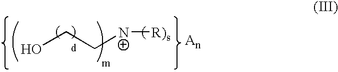
wherein A and n are as defined in formula (I), d is 1 or 2, R represents a hydrogen atom or a R¹ group as defined in formula (I), m is 2 or 3 and (m+s)=4.

The proportions in which the compounds according to the invention can be incorporated into the various aforementioned compositions or articles vary within a wide range of values. These values are dependent on the nature of the composition or product as well as the nature of the co-ingredients in a given composition.

For example, typical concentrations of the compound of formula (I) in one of the aforementioned product are in the order of 0.01% to 10% by weight, percentage being based on the weight of the article into which they are incorporated. Concentrations higher than these, such as in the order of 2% to 80% by weight, can be used when these compounds are incorporated into compositions.

### EXAMPLES

The invention will now be described in further details by way of the following examples, wherein the abbreviations have the usual meaning in the art, the temperatures are indicated in degrees centigrade (° C.); ¹H-NMR spectral data were recorded at 360 MHz and ¹³C NMR spectra were recorded at 100 MHz in CDCl₃, the chemical displacement δ are indicated in ppm with respect to the TMS as standard, and all the abbreviations have the usual meaning in the art.

### Example 1

### Synthesis of [1,2-bis(isostearoyloxy)propyl]trimethylammonium methyl sulfate

### a) Synthesis of the 1-[N,N-dimethylamino)methyl]-1,2-ethanediyl bis(isostearate)

The reaction was performed using dry solvents and under a N₂ stream.

To 34.08 g of isostearic acid (Emersol® 874; origin: Cognis) at 60° C. were added dropwise 8.7 ml of SOCl₂. The mixture was stirred at 60° C. for 15 minutes, then cooled and diluted with 150 ml of CH₂Cl₂. To this mixture was added dropwise a solution of 5.95 g of 3-(dimethylamino)-1,2-propanediol and 16.7 ml of triethylamine in 150 ml CH₂Cl₂. After 15 minutes, the solution was washed twice with 300 ml of water at pH=10 (basified with NaOH). The organic phase, which contained the raw product, was then evaporated to dryness and the raw product was purified by flash chromatography on a SiO₂ column eluted successively by CH₂Cl₂ and ethyl acetate.

14.82 g of product were obtained (yield=46%). The product was used as obtained in the following step, without characterization.

Emersol® 874 contains approximately 90% w/w of branched C₁₈ carboxylic acids, amongst which there are linear C₁₇ fatty acids substituted with a methyl group, for example in the position 8, 9 or 10, C₁₈ fatty acids of formula H—(CH₂)ₓ—C₆H₄—(CH₂)_{y}—COOH or H—(CH₂)ₓ—C₆H₁₀—(CH₂)_{y}—COOH, wherein (x+y)=11, and C₁₈ fatty acids of formula H—(CH₂)_{w}—C₅H₈—(CH₂)_{z}—COOH, wherein (z+w)=12.

### b) Synthesis of [1,2-bis(isostearoyloxy)propyl]trimethylammonium methyl sulfate

14.82 g of 1-[(N,N-dimethylamino)methyl]-1,2-ethanediyl bis(isostearate), as obtained above, were diluted with 20 ml isopropanol and heated at 60° C. 1.9 ml of dimethylsulfate were added, and the mixture was stirred for 15 minutes. The reaction mixture was then evaporated to dryness and the raw product was purified by flash chromatography on a SiO₂ column eluted by ethyl acetate. 10.54 g of the desired product were obtained (yield=66%).

¹H-RMN: 5.6-5-4 (m, 1H), 4.65-4.35 (m, 1H), 4.15-4.0 (m, 2H), 3.79-3.65 (m, 1H), 3.7 (s, 3H), 3.34 (s, 9H), 2.65-2.2 (m, 6H), 1.9-1.49 (m, 4H), 1.49-0.98 (m, 51H), 0.98-0.74 (m, 12H).
Integrations are indicative as the signals are broad due to the large number of isomers present in the isostearic acid.

¹³C-RMN: 173.2 (s), 172.8 (s), 66.0 (d), 65.8 (t), 63.2 (t), 54.5 (q), 54.1 (q), 37.1 (t), 34.2 (t), 33.9 (t), 32.8 (t), 32 (t), 30.3-28.9 (several unresolved t), 27.1 (t), 26.8 (t), 24.8 (t), 24.7 (t), 23.2 (t), 22.7 (t), 19.7 (q), 14.1 (q).

### Example 2

### Use of [1,2-bis(isostearoyloxy)propyl]trimethylammonium methyl sulfate as anti-gelling or viscosity-control agent

Three different softeners were formulated according to the following protocol:

Water (93% w/w) and surfactant and/or compound of formula (I) (total of 7% w/w) were mixed together and heated up at 65° C., kept for 10 minutes under mechanical stirring and subsequently cooled down at room temperature. Each of the softeners thus obtained is a fluid milky dispersion of brownian spherical surfactant aggregates, whereas as for “fluid” is intended a free-flowing liquid.

TABLE 1
Composition of the softeners

| | | Non-linear |
|---|---|---|
| Softener | Linear surfactant¹⁾ | fatty acid derivative²⁾ |
| 1 | 7% | — |
| 2 | — | 7% |
| 3 | 6% | 1% |

¹⁾[1,2-bis(palmitoyloxy)propyl]trimethylammonium methyl sulfate
²⁾[1,2-bis(isostearoyloxy)propyl]trimethylammonium methyl sulfate

Then, to said three softeners were added 1% w/w of a perfumery alcohol and, after stirring, the new perfumed softeners were kept for 15 days at room temperature; the results are summarized in Table 2.

TABLE 2
Physical status of the perfumed softener bases after 15 days of storage

| | Perfumery alcohol | | |
|---|---|---|---|
| Softener | hexanol | nonanol | dodecanol |
| 1 | gelled solid | gelled solid | highly viscous, almost solid |
| 2 | fluid | fluid | fluid |
| 3 | fluid | fluid | fluid |

As shown in Table 2, the addition of a non-linear fatty acid derivative according to the invention prevents efficiently the gelling of a perfumed softener base.

### Example 3

### Use of [1,2-bis(isostearoyloxy)propyl]trimethylammonium methyl sulfate as anti-gelling or viscosity-control agent

A softener (referenced as Softener 1) was obtained by admixing the following ingredients:

| Ingredients | Parts by weight |
|---|---|
| Water | 86.75 |
| Brij ® 35¹⁾ | 0.75 |
| Hydrogenated Stepantex ® VK90²⁾ | 12.50 |
| Total | 100.00 |

¹⁾non ionic surfactant from Unichema
²⁾Stepantex ® VK90 is a product from Stepan Ltd

Another softener (referenced as Softener 2) and containing an anti-gel ingredient according to the invention was obtained by admixing the following ingredients:

| Ingredients | Parts by weight |
|---|---|
| Softener 1 | 99 |
| [1,2-bis(isostearoyloxy)propyl]trimethylammonium | 1 |
| methyl sulfate | |
| Total | 100 |

The evolution of the appearance of Softener 1 or 2 upon aging at two different temperatures was followed in the absence of perfume or in the presence of 0.75 parts by weight of a perfuming compound. The results are reported in Table 3:

TABLE 3
Physical status of the perfumed softener bases after aging

| | Softener 1 | | | | Softener 2 | | | |
|---|---|---|---|---|---|---|---|---|
| | 25° C. | | 37° C. | | 25° C. | | 37° C. | |
| | Day 1 | Day 14 | Day 1 | Day 15 | Day 1 | Day 14 | Day 1 | Day 15 |
| Without | 0 | 0 | 0 | 3 | 0 | 0 | 0 | 2 |
| perfume | | | | | | | | |
| Dihydro | 0 | 4 | 0 | 3 | 0 | 2 | 0 | 0 |
| myrcenol | | | | | | | | |
| Geraniol | 2 | 4 | 2 | 4 | 0 | 2 | 0 | 1 |
| Terpineol | 0 | 0 | 0 | 4 | 0 | 0 | 0 | 1 |
| Hedione ®¹⁾ | 0 | 0 | 0 | 4 | 0 | 0 | 0 | 1 |

0: liquid, fluid
1: liquid slightly viscous
2: viscous liquid
3: viscous liquid almost solid
4: solid
¹⁾methyl dihydrojasmonate; origin: Firmenich SA, Geneva, Switzerland

As shown in Table 3, the addition of a non-linear fatty acid derivative according to the invention prevents or delays efficiently the gelling of a softener.

1. A compound of formula I: 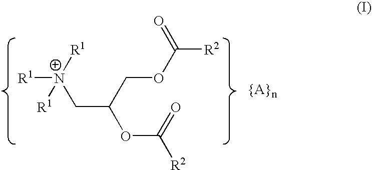
wherein n is 0.5 or 1;
A represents an anion of an acid such as a chloride, a bromide, a iodide, a CO₃²⁻ or HCO₃⁻, a sulfate, a methyl or ethyl sulfate, a tosylate or a nitrate; and
each R¹ represents, simultaneously or independently, a hydrogen or oxygen atom, a benzyl or C₁ to C₆ alkyl group or a polyethylene- or polypropyleneglycol group, having from 1 to 5 monomer units; and
each R² represents, simultaneously or independently, a C₁₀-C₃₀ saturated or unsaturated hydrocarbon radical having at least a tertiary carbon atom, or a C₁₀-C₃₀ saturated or unsaturated hydrocarbon radical having from one to six —OCOR³ or —OR³ groups bonded to its hydrocarbon chain; R³ being a hydrogen atom, or a C₁-C₂₂ saturated or unsaturated hydrocarbon group.

2. The compound of claim 1, wherein n is 0.5 or 1;
A represents a chloride, a bromide, a iodide, a sulfate or a methyl or ethyl sulfate;
each R¹ represents, simultaneously or independently, an oxygen atom, a benzyl or C₁ to C₆ alkyl group or a —[CH₂CH₂O]_{q}H group, q being an integer from 1 to 3; and
each R² represents, simultaneously or independently, a C₁₄-C₁₈ saturated or unsaturated hydrocarbon radical having at least a tertiary carbon atom, or a C₁₄-C₂₀ saturated or unsaturated hydrocarbon radical having from one to six —OCOR³ or —OR³ groups bonded to its hydrocarbon chain; R³ being an hydrogen atom, or a C₁-C₁₈ saturated or unsaturated hydrocarbon group.

3. The compound of claim 1, wherein n is 0.5 or 1;
A represents a chloride, a bromide, a iodide, a sulfate or a methyl or ethyl sulfate;
each R¹ represents, simultaneously or independently, a benzyl or C₁ to C₆ alkyl group; and
each R² represents, simultaneously or independently, a C₁₄-C₁₈ saturated or unsaturated hydrocarbon radical having from one to six tertiary carbon atoms.

4. The compound of claim 3, wherein at least one of the R² is a C₁₅-C₁₆ linear hydrocarbon substituted with one or two methyl groups or a C₁₇ hydrocarbon containing a cyclic moiety and one or two chain moieties.

5. An anti-gelling or viscosity control agent comprising a compound according to claim 1.

6. A composition of matter comprising at least a compound of formula (I) according to claim 1 and a perfume base.

7. A composition of matter consisting of at least a compound of formula (I), as defined in claim 1 and a perfume base.

8. A softening article comprising:
a) a compound of formula (I), as defined in claim 1, and
b) a softening base.

9. An article according to claim 8, wherein the softening base is a fabric softener, a shampoo, a hair conditioner and another hair care product, a skin emollient or a cosmetic product.

10. An article according to claim 8, wherein the softening base contains at least a surfactant obtainable by the reaction of one to three molar equivalents of a C₁₀-C₂₀ fatty acid with one molar equivalent of an amino alcohol of formula 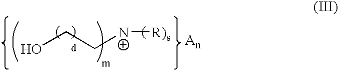
wherein A and n are as defined in claim 1, d is 1 or 2, R represents a hydrogen atom or a R¹ group as defined in claim 1, m is 2 or 3 and (m+s)=4.

11. A softening article comprising:
a) a composition of matter, as defined in claim 5, and b) a softening base.

12. An article according to claim 11, wherein the softening base is a fabric softener, a shampoo, a hair conditioner and another hair care product, a skin emollient or a cosmetic product.

13. An article according to claim 11, wherein the softening base contains at least a surfactant obtainable by the reaction of one to three molar equivalents of a C₁₀-C₂₀ fatty acid with one molar equivalent of an amino alcohol of formula 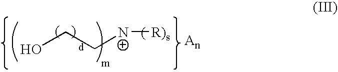
wherein A and n are as defined in claim 1, d is 1 or 2, R represents a hydrogen atom or a R¹ group as defined in claim 1, m is 2 or 3 and (m+s)=4.

14. A softening article comprising:
a) a composition of matter, as defined in claim 5, and
b) a softening base.

15. An article according to claim 14, wherein the softening base is a fabric softener, a shampoo, a hair conditioner and another hair care product, a skin emollient or a cosmetic product.

16. An article according to claim 14, wherein the softening base contains at least a surfactant obtainable by the reaction of one to three molar equivalents of a C₁₀-C₂₀ fatty acid with one molar equivalent of an amino alcohol of formula 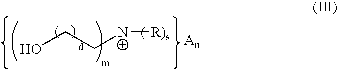
wherein A and n are as defined in claim 1, d is 1 or 2, R represents a hydrogen atom or a R¹ group as defined in claim 1, m is 2 or 3 and (m+s)=4.

17. A method for preventing or delaying gelation of a softener composition, which comprises adding to or incorporating in such composition a compound according to claim 1 in an amount effective to prevent or delay gelation of the softener composition.

18. A method for preventing or delaying gelation of a softener composition, which comprises adding to or incorporating in such composition an antigelling or viscosity control agent according to claim 5 in an amount effective to prevent or delay gelation of the softener composition.

19. A method for preventing or delaying gelation of a softener composition, which comprises adding to or incorporating in such composition a composition of matter according to claim 6 in an amount effective to prevent or delay gelation of the softener composition.

20. A method for preventing or delaying gelation of a softener composition, which comprises adding to or incorporating in such composition a composition of matter according to claim 7 in an amount effective to prevent or delay gelation of the softener composition.
